(19) United States
(12) Patent Application Publication
(10) Pub. No.: US 2015/0355769 A1
(43) Pub. Date: Dec. 10, 2015

(54) METHOD FOR PROVIDING USER INTERFACE USING ONE-POINT TOUCH AND APPARATUS FOR SAME

(71) Applicant: KOREA ELECTRONICS TECHNOLOGY INSTITUTE, Seongnam-si, Gyeonggi-do (KR)

(72) Inventors: Kunnyun KIM, Yongin-si, Gyeonggi-do (KR); Wonhyo KIM, Yongin-si, Gyeonggi-do (KR); Yeonhwa KWAK, Seoul (KR); Kwangbum PARK, Yongin-si, Gyeonggi-do (KR)

(73) Assignee: KOREA ELECTRONICS TECHNOLOGY INSTITUTE, Seongnam-si, Gyeonggi-do (KR)

(21) Appl. No.: 14/655,473

(22) PCT Filed: Dec. 24, 2013
(86) PCT No.: PCT/KR2013/012136

§ 371 Date: Jun. 25, 2015

(30) Foreign Application Priority Data
Dec. 26, 2012 (KR) 10-2002-0152885
Dec. 26, 2012 (KR) 10-2012-0152886

(51) Int. Cl. G06F 3/041; G06F 3/0481; G06F 3/0488

(52) U.S. Cl. CPC G06F 3/0414; G06F 3/0488; G06F 3/04815; G06F 2203/04104; G06F 2203/04806

(57) ABSTRACT

The present invention relates to a method for providing a user interface using a one-point touch capable of immediately carry out various user commands by changing the direction of force applied to a fixed contact point, and to an apparatus for same, wherein when contact on one point inside a touch area is sensed, the direction of force applied to the point or a pattern with respect to a change in the direction of the force is detected while the contact is maintained on the one point, and a predetermined user command is carried out according to the direction of the force or the pattern with respect to the change in the direction of the force.

### TECHNICAL FIELD

The present invention relates to a touch-type user interface, and more particularly, to a method and apparatus for providing a user interface using a one-point touch in which a user may execute various user commands with a one touch operation without needing to perform a complex touch gesture such as tapping, dragging, sliding, or pinching or without drawing a predetermined pattern.

### BACKGROUND ART

These days, there are many types of input devices such as a key pad including multiple buttons or keys, a mouse, a track ball, a touch pad, a joystick, a touch screen, or the like in order to manipulate a computer system. Such input devices are used to input data such as a letter, a symbol, a picture, or the like desired by users to a computer system and input a signal for requesting a specific command from the computer system.

Among the various input devices, recently, a touch input means such as a touch screen that can minimize and simplify a user device by implementing an input means and an output function together is generally used.

A touch input means may sense contact with a touch region by a contact means such as a user's body part or touch pen and may be classified into a resistive type, a capacitive type, and an optical type. The resistive-type touch input means senses a touch by recognizing a pressure applied to a contact point by the touch, the capacitive-type touch input means senses a touch through a change in an electric charge on a contact point caused by the contact of a human body part of a user, and the optical-type touch input means detects a touch position using an infrared light camera and an infrared light lamp.

An initial method for providing a user interface using this touch input means displays a manipulation means such as multiple buttons on a screen and performs a corresponding function based on a position where contact is sensed. Recently, in order to enhance a user's convenience and operability, a method of combining a variety of information such as a contact start position, a contact start time, a contact end position, and a contract end time, recognizing a touch gesture such as tapping, dragging, sliding, and pinching, and executing various user commands according to the touch gesture has also been used. In addition, a method of recognizing multiple touch points in a touch region and executing a user command according to the number of, positions of, combinations of, and distance changes between the touch points has been used.

However, a conventional user interface method using a touch has difficulties in user manipulation with only one hand because a user performs a complex touch gesture or touches several points to draw a complex pattern.

In addition, the conventional user interface method has limitations in providing an instant response because it takes a certain time to perform and then recognize a touch gesture or touch pattern.

### DISCLOSURE

### Technical Problem

The present invention has been proposed to solve the above-described problems and intends to provide a method and apparatus for providing a user interface using a one-point touch in which a user may execute various user commands with a one touch operation without needing to perform a complex touch gesture such as tapping, dragging, sliding, or pinching or without drawing a predetermined pattern.

In particular, the present invention intends to provide a method and apparatus for providing a user interface using a one-point touch in which a user may instantly execute various user commands by changing directions of force applied to a contact point in the touch region.

### Technical Solution

One aspect of the present invention provides a method of providing a user interface using a one-point touch, the method being performed by an apparatus that includes a touch region capable of sensing contact and the method including: sensing contact with one point in the touch region; when the contact is sensed, detecting a direction of force applied to the point while the contact with the point is fixed; and executing a predetermined user command according to the detected direction of force.

Another aspect of the present invention provides a method of providing a user interface using a one-point touch, the method being performed by an apparatus that includes a touch region capable of sensing contact and the method including: sensing contact with one point in the touch region; when the contact is sensed, detecting a direction of force applied to the point at certain intervals while the contact with the point is fixed; detecting a change pattern of the direction of force according to when the direction of force is detected; and executing a predetermined user command according to the detected change pattern.

The detecting of the direction of force may include: extracting a contact region with a certain area around the point where the contact is sensed; detecting intensities of the force at multiple sensing points in the contact region; and determining a direction of the force applied to the point based on a distribution of the detected intensities of the force at the multiple sensing points.

The determining of the direction of force may include determining, as the direction of force, a direction of a sensing point where a greatest intensity of force is detected with respect to the center of the contact region.

The determining of the direction of force may include determining the direction of force in a two-dimensional (2D) plane based on the touch region or in a three-dimensional (3D) space further including a downward direction perpendicular to the touch region.

The executing of the predetermined user command may include performing one or more of rotation, movement, zooming-in, zooming-out, panning, and tilting of a specific object or screen according to the direction of force.

The method may further include detecting an intensity of the force applied to the point, in which the executing of the user command includes executing the user command in further consideration of the intensity of the force in addition to the detected change pattern of the direction of force.

The extracting of the change pattern may include sequentially connecting detected directions of force to extract the change pattern of the direction of force.

Still another aspect of the present invention provides an apparatus including: a touch input unit including a touch region capable of sensing contact and configured to detect one or more of contact with the touch region, a position of the contact, an intensity of force when the contact is applied, and a direction of the force; and a control unit configured to, when contact with one point in the touch region is sensed, detect a direction of force applied to the point or a change pattern of the direction of force while the contact to the point is fixed and execute a predetermined user command according to the detected direction of force or the detected change pattern of the direction of force.

The control unit may include a touch event processing module configured to set a contact region with a certain area around the point where the contact is sensed, compare intensities of force at multiple sensing points located in the contact region, and determine the direction of force applied to the point.

The touch event processing module may determine, as the direction of force, a direction of a sensing point where a greatest intensity of force is detected with respect to a center of the contact region.

The control unit may include a change pattern extraction module configured to extract a change pattern of the direction of force by sequentially connecting directions of force detected within a certain time period while the contact with the point is fixed.

### Advantageous Effects

The method and apparatus for providing a user interface using a one-point touch according to the present invention have an excellent effect of executing various user commands by sensing contact with one point of a touch region, detecting a direction of force applied to the point while the contact with the point is held without changing a position of the contact, executing a user command according to the detected direction of force, and thus adjusting only the direction of force applied to the contact point without moving from a user touch at the specific point or drawing a complex pattern.

In particular, the present invention can enhance a user's convenience because the manipulation is enabled by adjusting the direction of force without moving the position after coming into contact with the specific point when the user manipulates a portable user device such as smartphone with one hand.

In addition, the present invention has an excellent effect of providing an instant and quick response result to a user by executing the user command according to the direction of force applied to the contact point.

### DESCRIPTION OF DRAWINGS

FIG. 1 is a block diagram showing an apparatus for providing a user interface using a one-point touch according to an embodiment of the present invention.

FIG. 2 is a flowchart showing a method of providing a user interface using a one-point touch according to a first embodiment of the present invention.

FIG. 3 is a flowchart showing a method of providing a user interface using a one-point touch according to a second embodiment of the present invention.

FIG. 4 is a flowchart showing a method of detecting a direction of force in a method of providing a user interface using a one-point touch according to the present invention.

FIG. 5 is an exemplary diagram of a user interface screen using a one-point touch according to a first embodiment of the present invention.

FIG. 6 is a schematic diagram for describing a direction of force detected in a first embodiment of the present invention.

FIGS. 7 to 9 are exemplary diagrams showing an execution status of a user command according to a direction of force in a method of providing a user interface according to a first embodiment of the present invention.

FIG. 10 is an exemplary diagram showing an execution status of a user command by clockwise rotation of the direction of force in a user interface screen using a one-point touch according to a second embodiment of the present invention.

FIG. 11 is a schematic diagram for describing a method of extracting a change pattern of a direction of force applied to a fixed contact point according to a second embodiment of the present invention.

FIG. 12 is a mapping table of user commands and patterns in which a direction of force changes according to a second embodiment of the present invention.

FIG. 13 is a schematic diagram for describing a principle of detecting the direction of force with respect to a contact point in a method of providing a user interface according to an embodiment.

### MODES OF THE INVENTION

Hereinafter, preferred embodiments of the present invention will be described in detail with reference to the accompanying drawings. However, detailed descriptions related to well-known functions or configurations will be omitted in order not to unnecessarily obscure subject matters of the present invention. In addition, it should be noted that like reference numbers denotes like elements throughout the specification and drawings.

A method of providing a user interface using a one-point touch according to the present invention may be implemented by an apparatus including a touch region that can sense contact by a contact means such as a user's body part (e.g., finger) or touch pen. Any apparatus may be used as the apparatus as long as it includes a touch input means such as a touch screen that can sense a touch and output a screen at the same time or a touch pad that can sense a touch operation. For example, an apparatus for providing an user interface using a one-point touch according to the present invention may be one of a smartphone, a cell phone, a tablet PC, a laptop, a desktop, and a personal digital assistant (PDA).

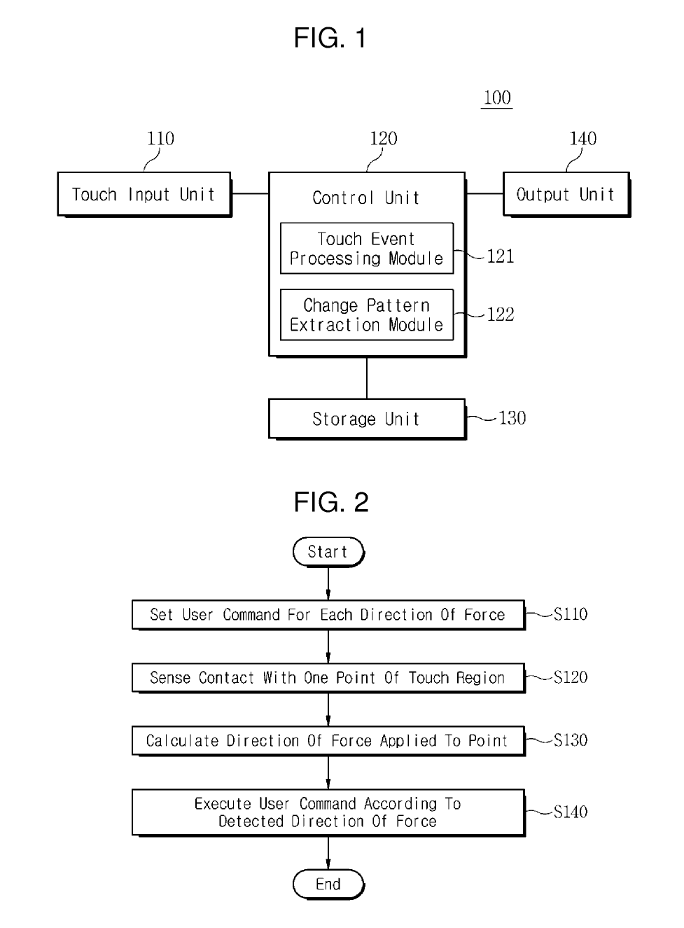

The above-described apparatus for providing a user interface using a one-point touch according to the present invention will be described with reference to FIG. 1.

FIG. 1 is a block diagram showing a configuration of an apparatus for providing a user interface using a one-point touch according to the present invention. Although FIG. 1 shows a configuration of an apparatus, focusing on the components needed to perform a user interface according to the present invention, the apparatus may further include other components or functions in addition to the needed components. Moreover, for convenience of description, it should be understood that components to be described below are represented in units of functions and may be actually implemented by hardware, software, or a combination thereof.

Referring to FIG. 1, an apparatus 100 for providing a user interface according to the present invention may be configured to include a touch input unit 110, a control unit 120, a storage unit 130, and an output unit 140.

The touch input unit 110 includes a touch region that can sense contact and senses a variety of information associated with a contact operation to the touch region. Specifically, the touch input unit 110 may sense contact, a position of the contact, an intensity of force of the contact, and a direction of the force. The touch input unit 110 may be implemented as either a touch pad or a touch screen and also sense a variety of information associated with the contact operation in one or more of a resistive scheme, a capacitive scheme, an optical scheme, and an ultrasonic scheme.

Moreover, the touch input unit 110 may include multiple sensing points spaced a certain distance apart and sense one or more of contact, a position of the contact, an intensity of force of the contact, and a direction of the force through the multiple sensing points.

Information corresponding to one or more of contact with one point in the touch region, a position of the contact, an intensity of force of the contact, and the direction of the force that are detected by the touch input unit 110 is delivered to the control unit 120.

The control unit 120 is configured to perform a main process for providing a user interface using a one-point touch according to the present invention. When contact with one point in the touch region is sensed through the touch input unit 110, the control unit 120 performs control such that a predetermined user command is executed using the detected direction of force applied to the point while the contact with the point is fixed. Here, as described above, the user command may include one or more of rotation, movement, panning, tilting, zooming-in, and zooming-out of a screen or a specific object output to the screen. However, the user command is not limited thereto and may be used to instruct more various functions to be performed.

In a first embodiment of the present invention, by mapping a different user command to each direction of force when contact is applied, the control unit 120 may allow a different user command to be executed according to the direction of force.

In addition, in a second embodiment of the present invention, by setting a different user command for each change pattern of a direction of force while a touch is held, the control unit 120 may allow a different user command to be executed according to the change pattern of the direction of force.

To this end, the control unit 120 according to another embodiment of the present invention extracts a change pattern of a direction of force applied to a contact point in the touch region within a certain time period from a sensing signal input from the touch input unit 110. Here, the change pattern of the direction of force may include, for example, a counterclockwise direction rotation, a clockwise direction rotation, a left-to-right change, a right-to-left change, an up-to-down change, a down-to-up change, etc. For reference, the counterclockwise direction rotation denotes that the direction of force changes in a counterclockwise direction, the clockwise direction rotation denotes that the direction of force changes in a clockwise direction, the left-to-right change denotes that the direction of force is leftward and then switches to the opposite direction, the right-to-left change denotes that the direction of force is rightward and then switches to the opposite direction, the up-to-down change denotes that the direction of force is upward and then switches to the opposite direction, and the down-to-up change denotes that the direction of force is downward and then switches to the opposite direction.

In order to process the above-described functions, the control unit 120 may include one or both of a touch event processing module 121 and a change pattern extraction module 122.

When the touch input unit 110 cannot detect the direction of force, the touch event processing module 121 is configured to determine the direction of force using information (e.g., the intensity of force) output from the touch input unit 110.

The touch event processing module 121 sets a contact region with a certain area around the point where the contact is sensed in the touch region, compares the intensities of force at multiple sensing points located in the contact region, and determines a direction of force applied to the point. More specifically, the touch event processing module 121 may determine the direction of force according to the distribution of the intensities of force that are detected at the multiple sensing points included in the contact region. For example, when the intensity of force detected at the left side of the contact region is greater, the direction of force is determined to be left. When the intensity of force detected at the right side of the contact region is greater, the direction of force is determined to be right. In addition, the touch event processing module 121 may determine, as the direction of force, a direction of a sensing point where the greatest intensity of force is detected with respect to the center of the contact region.

Furthermore, the change pattern extraction module 122 is configured to extract the pattern of change when the user command is executed according to the change pattern of the direction of force according to a second embodiment of the present invention.

The change pattern extraction module 122 analyzes directions of force that are detected by the touch event processing module 121 within a certain time period and extracts the pattern of change. Specifically, the change pattern extraction module 122 may sequentially connect the directions of force that are detected by the touch event processing module 121 within a certain time period and extract the change pattern of the direction of force. For this, the touch event processing module 121 may detect the direction of force applied to the contact region at predetermined sampling intervals, and the change pattern extraction module 122 may sequentially connect the directions of force detected by the touch event processing module 121 to extract the change pattern of the direction of force.

The storage unit 130 is configured to store programs and data for operations of the apparatus 100. In particular, the storage unit 130 may store a program for a touch event process executed by the control unit 120 and a program for executing a user interface using a one-point touch according to the present invention and may further store one or both of setting information obtained by mapping directions of force with user commands to be executed when the directions of force are detected and setting information obtained by mapping patterns of change in the direction of force with user commands to be executed when the change pattern of the direction of force are detected.

The control unit 120 may perform execution based on programs and data stored in the storage unit 130 to provide a user interface according to the present invention.

Last, the output unit 140 is configured to output a user interface screen according to a control of the control unit 120. For example, the output unit 140 may be formed using various types of display panels such as liquid crystal display (LCD) or an organic light emitted diode (OLED). In addition, the output unit 140 may be implemented as a structure including a display panel and a touch panel, for example, a touch screen according to the fabricated form. When a display device is formed in the form of a touch screen, the output unit 140 and the touch input unit 110 may be implemented as one body.

For reference, an example of executing the user command has been described above on the basis of a direction of force or a change pattern of the direction of force when a touch is applied. However, the present invention may execute a user command in further consideration of another touch element (e.g., an intensity of force, a degree of change in a direction of force, and a contact time) on the basis of the direction of force or the change pattern of the direction of force. For example, the present invention may extract a user command to be executed according to the direction of force or the change pattern of directions of force, and may further adjust a degree of execution (e.g., a magnification, a moving distance, and a rotation angle) of the extracted user command according to any one of an intensity of force, a degree of change in a direction of force, and a contact time.

A process of providing a user interface using a one-point touch of the apparatus 100 for providing a user interface according to the present invention will be described in more detail below by specific embodiments.

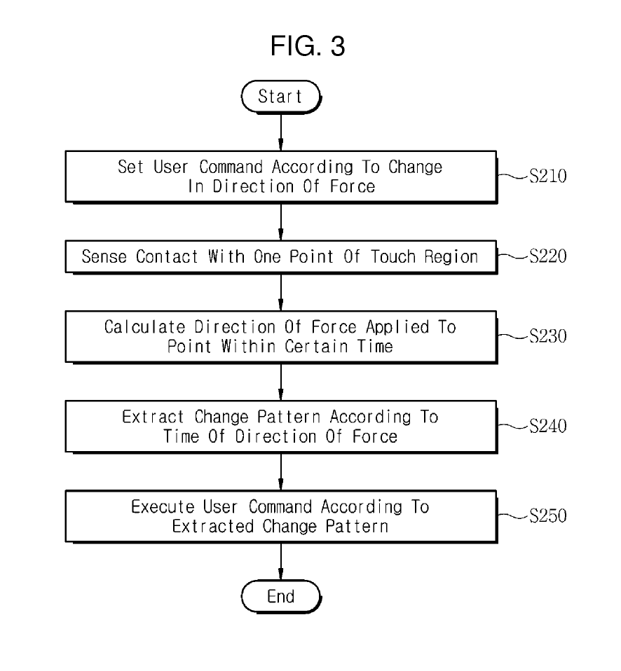

First, FIG. 2 is a flowchart showing a method of providing a user interface using a one-point touch according to a first embodiment of the present invention.

Referring to FIG. 2, in step S110, the apparatus 100 for providing a user interface using a one-point touch according to the present invention may map and set a user command that instructs a different function to be performed according to a detectable direction of force. Step S110 may be performed according to a user's selection and may be predetermined as a default operation irrespective of the user's selection. Step S110 may be omitted when the user command is predetermined in the apparatus 100 for each direction of force.

Next, in step S120, the apparatus 100 senses contact with one point of a touch region through the touch input unit 110. Here, the contact with one point in the touch region may be sensed through one of a resistive scheme, a capacitive scheme, an optical scheme, and an ultrasonic scheme. In addition, step S120 may be understood as a process of checking whether a touch input is sensed by a touch input means such as a touch screen or a touch pad that senses contact through one of the resistive scheme, the capacitive scheme, the optical scheme, and the ultrasonic scheme. Here, the contact point may be one point of a region where an object or a screen to be manipulated by a user is displayed within a touch region or one point of a region that is predetermined as a region for a user's manipulation according to the direction of force within the touch region.

As such, in step S130, when contact with one point in the touch region is sensed, the control unit 120 of the apparatus 100 according to the present invention detects the direction of force applied to the point while the contact with one point in the touch region is fixed. Here, the direction of force denotes the direction of force applied to a touch plane of a specific point in the touch region as the contact is applied to the point. The direction of force is different from a direction of touch in which a contact point is changed by a touch gesture such as dragging or sliding. Typically, the direction of touch denotes a direction from an initial contact position to a contact position after a certain time or to a final contact position, in which a sensed contact position varies with time. However, the direction of force sensed in step S130 is a value in which a position value of a contact point where a touch has occurred is not changed. The direction of force may be represented in a form that extends radially around the point where the contact has occurred and may be represented by an angle value of 0 to 360 degrees or east/west and/or north/south, or front/rear and/or left/right with respect to a predetermined reference axis.

When the direction of force applied to the point where the contact has occurred is detected, in step S140, the control unit 120 of the apparatus 100 according to the present invention executes a predetermined user command according to the detected direction of force.

Here, the executed user command is used to instruct a predetermined operation to be performed for a screen or a specific object output to a user interface screen. For example, the user command may include one or more of rotation, movement, zooming-in, zooming-out, panning, and tilting of the specific object or screen.

As described above, the user may execute various user commands by touching a specific point in the touch region and then adjusting only the direction of force applied to the point without needing to perform a touch gesture such as dragging or sliding.

Furthermore, in the method of providing a user interface according to the present invention, in step S130, the direction of force applied to the contact point may be detected in various manners. For example, the direction of force may also be sensed through a sensor that may detect the direction of force applied to the contact point according to the touch operation. When the touch input means included in the apparatus cannot detect the direction of force, the present invention may determine the direction of force using information detectable by the touch input means through the touch event processing module 121.

In addition, the above-described embodiment has described only the execution of a user command according to the direction of force. However, a method of providing a user interface according to the present invention may execute the user command in further consideration of one or more different pieces of information (e.g., the intensity of force applied to the contact point) in addition to the direction of force. By further considering the direction of force and one or more different pieces of information, the method may execute more various user commands.

Rather than the direction of force as described above, a user interface may be provided using a change pattern of the direction of force.

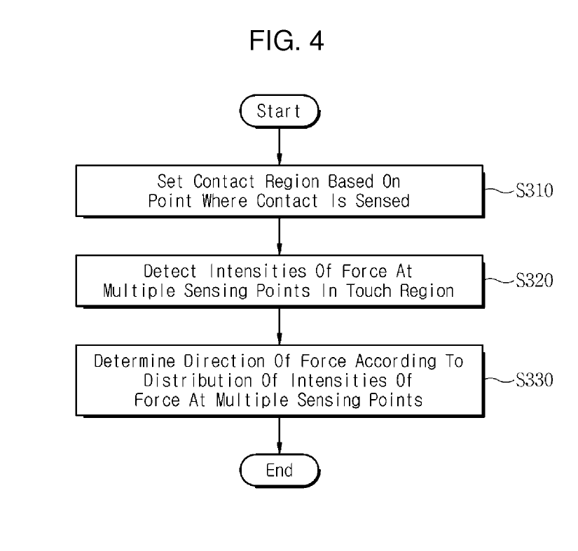

FIG. 3 is a flowchart showing a method of providing a user interface using a one-point touch according to a second embodiment of the present invention and illustrates a method of providing a user interface using a change pattern of the direction of force.

Referring to FIG. 3 and according to a second embodiment of the present invention, in step S210, the apparatus 100 for providing a user interface using a one-point touch may map and set a user command that instructs a different function to be performed according to one or more detectable patterns of change in the direction of force. Step S210 may be performed according to a user's selection and may be predetermined in the apparatus 100 as a default operation during a production or distribution stage, irrespective of the user's selection. That is, step S210 may be omitted when the user command is predetermined in the apparatus 100 according to the change pattern of the direction of force.

Next, in step S220, the apparatus 100 senses contact with one point of a touch region through the touch input unit 110. Here, the contact with one point in the touch region may be sensed through one of a resistive scheme, a capacitive scheme, an optical scheme, and an ultrasonic scheme. In addition, step S220 may be understood as a process in which the control unit 120 checks whether a touch is sensed through a touch input unit 110 that is implemented as a touch screen or a touch pad that senses contact through one of the resistive scheme, the capacitive scheme, the optical scheme, and the ultrasonic scheme. Here, the contact point may be one point of a region where an object or a screen to be manipulated by a user is displayed within a touch region provided by the touch input unit 110 or one point of a region that is predetermined as a region for a user's manipulation according to the direction of force within the touch region.

As such, when contact with one point in the touch region is sensed, in step S230, the control unit 120 of the apparatus 100 according to the present invention detects the direction of force applied to the point while the contact with one point in the touch region is fixed. Here, the direction of force denotes the direction of force applied to a touch plane of a specific point in the touch region as the contact is applied to the point. The direction of force is different from the direction of touch in which a contact point is changed by a touch gesture such as dragging or sliding. Typically, the touch direction denotes a direction from an initial contact position to a contact position after a certain time or to a final contact position, in which a sensed contact position varies with time. However, in the direction of force sensed in step S230, a position value of a contact point where a touch has occurred is not changed. The direction of force may be represented in a form that extends radially around the point where contact has occurred and may be represented by an angle value within the range of 0 to 360 degrees or east/west and/or north/south, or front/rear and/or left/right with respect to a predetermined reference axis. Moreover, in step S230, the direction of force may be repeatedly detected at predetermined sampling intervals while the contact with the point is fixed. Step S130 may be performed by the touch event processing module 121 of the control unit 120.

Upon detecting the direction of force applied to the point where the contact has occurred, in step S240, the control unit 120 of the apparatus 100 according to the present invention extracts a change pattern of the direction of force that is detected over a certain time. Step S240 may be performed by the change pattern extraction module 122 of the control unit 120. Specifically, the change pattern extraction module 122 extracts a pattern of change by arranging and connecting directions of force applied to a point where contact is fixed, which are detected for a certain time, in the order of a detection time. Here, the pattern of change may include, for example, a counterclockwise direction rotation, a clockwise direction rotation, a left-to-right change, a right-to-left change, an up-to-down change, a down-to-up change, etc.

As such, when the change pattern of the direction of force applied to the contact point is extracted, in step S250, the control unit 120 of the apparatus 100 according to the present invention executes a predetermined user command according to the detected direction of force. Here, the executed user command is used to instruct a predetermined operation for a screen or a specific object output to a user interface screen to be performed. For example, the user command may include one or more of rotation, movement, zooming-in, zooming-out, panning, and tilting of the specific object or screen.

As described above, the user may execute various user commands by touching a specific point in the touch region and then changing the direction of force applied to the point without needing to perform a touch gesture such as dragging or sliding or without changing or moving the position of the contact.

In addition, a case in which a user command is executed on the basis of only the change pattern of the direction of force has been described. However, a method of providing a user interface according to the present invention may execute the user command in further consideration of another piece of information (e.g., the intensity of force, a degree of change in the direction of force, and a contact time) on the basis of the change pattern of the direction of force. For example, the method may extract a user command to be executed according to the change pattern of the direction of force, and also adjust a degree of execution (e.g., a magnification, a moving distance, and a rotation angle) of the user command according to any one of an intensity of force, a degree of change in a direction of force, and a contact time.

Further, in the method of providing the user interface according to the first or second embodiment, the direction of force applied to the contact point may be detected in various manners. For example, the direction of force may be sensed through a sensor that may detect the direction of force applied to the contact point according to the touch operation. When the touch input unit 110 included in the apparatus 100 cannot detect the direction of force, the method may determine the direction of force using information (the intensity of force) detectable by the touch input unit 110.

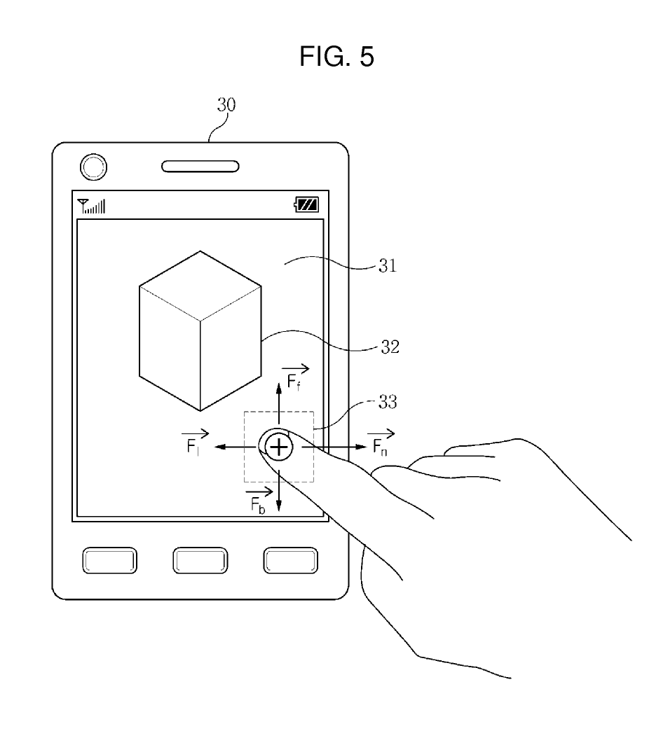

FIG. 4 is a flowchart showing a method of detecting a direction of force in a method of providing a user interface using a one-point touch according to an embodiment of the present invention.

Referring to FIG. 4, under a condition that the direction of force applied to the point where the contact is sensed is detected in steps S130 and S230, the control unit 120 of the apparatus 100 according to the present invention, in particular, the touch event processing module 121 sets a contact region with a certain area around the point where the contact is sensed as shown in step S310. Step S310 may also be achieved by setting a predetermined range of area as the contact region on the basis of the point or also by performing the setting by connecting one or more adjacent sensing points when an actual contact is sensed within the touch region. More specifically, the touch region typically includes multiple points spaced certain distances apart, and touch sensitivity may be changed according to the number of, a distance between, or a unit area of the sensing points. In the present invention, when contact is applied to a touch region by a contact means such as a user's finger or touch pen, the multiple sensing points may be spaced a distance smaller than the finger or touch pen such that the multiple sensing points may sense the contact. In this case, a region obtained by connecting the multiple sensing points that sense the contact applied by the user's finger or contact means within the touch region or a region with a predetermined area on the basis of the multiple sensing points may be set as the contact region.

When the contact region is set, the touch event processing module 121 according to the present invention detects intensities of the force at the multiple sensing points included in the contact region in step S320. Here, the intensities of the force may be represented by pressure levels.

In addition, the touch event processing module 121 may determine the direction of force according to the distribution of the intensities of force that are detected at the multiple sensing points included in the contact region in step S330. More specifically, the determination of the direction of force according to the intensity distribution of force includes detecting a direction in which a greater intensity of force is applied in the contact region as the direction of force. For example, a direction of a sensing point where the greatest intensity of force is detected with respect to the center of the contact region may be determined as the direction of force. Here, the direction of force may be represented by one of front/rear and/or left/right or east/west and/or north/south or may be represented by an angle with respect to a reference axis. In addition, the direction of force may be a direction in a two-dimensional (2D) plane based on the touch region or in a three-dimensional (3D) space further including a downward direction perpendicular to the touch region.

As such, in order to detect the direction of force applied to a point where the contact is sensed, the apparatus 100 according to the present invention may preferably detect one or more of contact with a specific contact point in the touch region, a position of the contact point, an intensity of force applied to the contact point, and a direction of the force.

The above-described method of providing a user interface according to the present invention may be implemented in the form of software that is readable by various computer means and may be recorded on a computer-readable recording medium. Here, the recording medium may include a program instruction, a data file, a data structure, or a combination thereof. The program instruction recorded on the recording medium may be designed and configured specifically for the present invention or can be publicly known and available to those who are skilled in the field of computer software. Examples of the recording medium include a magnetic medium such as a hard disk, a floppy disk, and a magnetic tape, an optical medium such as a CD-ROM, a DVD, etc., a magneto-optical medium such as a floptical disk, and a hardware device such as a ROM, a RAM, a flash memory, etc. that is specially configured to store and perform the program instruction. Examples of the program instruction include a high-level language code executable by a computer with an interpreter, in addition to a machine language code made by a compiler. The above exemplary hardware device can be configured to operate as one or more software modules in order to perform the operation of the present invention, and vice versa.

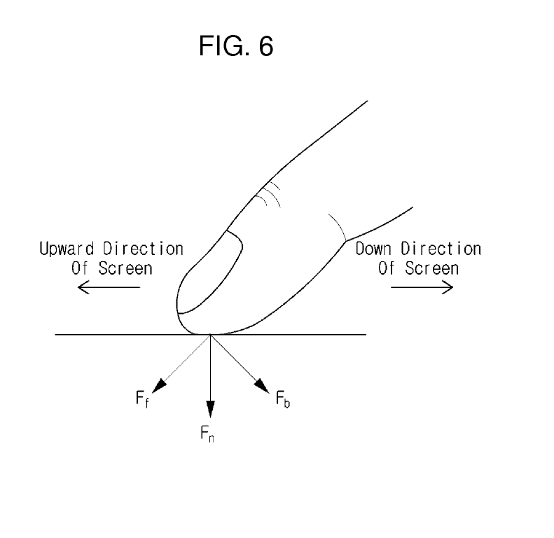

A method of providing a user interface using a one-point touch according to the present invention may be more easily understood by referencing the various examples shown in FIGS. 5 to 13.

Among them, FIG. 5 is an exemplary diagram for describing a user interface that uses a one-point touch according to a first embodiment of the present invention. Here, reference number 30 indicates an apparatus for providing a user interface using a one-point touch according to the present invention, which is a portable terminal device including a touch screen such as a smartphone. Reference number 31 indicates a user interface screen included in the portable terminal device 30. The user interface screen 31 includes a target to be manipulated by a user, that is, an object 32 to be manipulated by execution of a user command and a touch region 33 for manipulating the object 32.

In the above-mentioned embodiment, a portion of the user interface screen 31 may be represented as the touch region. However, the touch region 33 may be set as the entire user interface screen. Moreover, in the above-mentioned embodiment, a region separated from the object 32 to be manipulated by execution of the user command is represented as the touch region 33. However, the touch region 33 may be set as a region that is mapped to the object 32 to be manipulated by execution of the user command. In the latter case, the selection of the object to be manipulated by execution of the user command and the execution of the user command according to the direction of force may be performed almost simultaneously by touching the object 32.

In this case, when a user brings a finger into contact with one point in the touch region 33, the portable terminal device 30 senses the contact and detects a direction of force applied to the point by the user. The direction of force may be detected with respect to the center of the contact region with which the user's finger is in contact within the touch region 33, by using a value detected through a predetermined sensor provided in the touch region 33, that is, the intensity (pressure) of force.

The direction of force applied to a point in the touch region 33 where the contact is sensed may include one or more of a leftward direction \vec{F}ₗ, a rightward direction \vec{F}_{f}, an upward direction \vec{F}ⱼ, a downward direction \vec{F}_{b}, and a backward direction \vec{F}ₙ with respect to the screen.

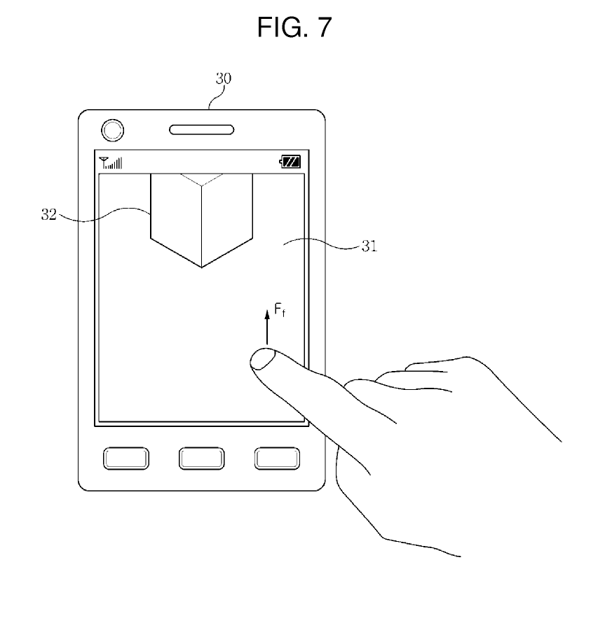

The upward direction \vec{F}ⱼ denotes a direction in which a force is directed in the upward direction of the screen as shown in FIG. 6 and may be detected corresponding to an action of a user pushing up on the screen. In addition, the downward direction \vec{F}_{b} denotes a direction in which a force is directed in the downward direction of the screen and may be detected corresponding to an action of a user pulling down on the screen. The backward direction \vec{F}ₙ denotes a direction in which a force is applied toward the back of the screen perpendicularly to the screen and may be detected corresponding to an action of a user pushing back on the screen.

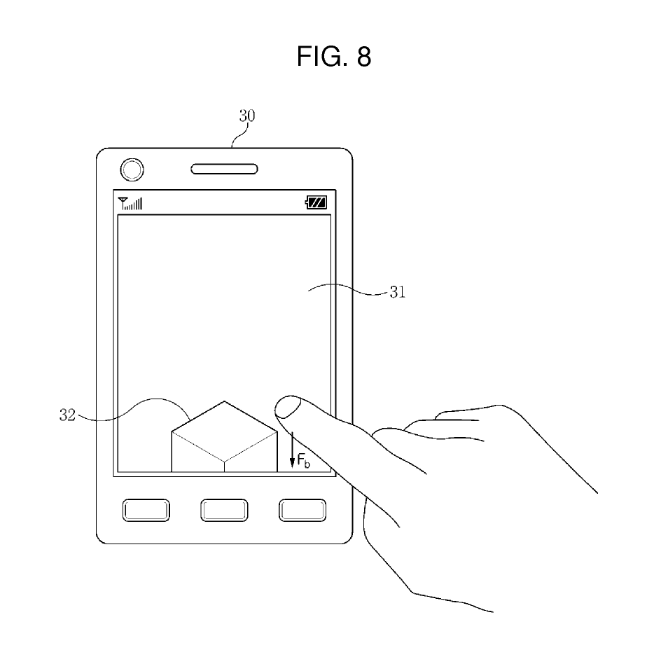

The user command according to the detected direction of force may be executed as shown in FIGS. 7 to 9.

FIG. 7 shows an execution status of a user command when a user applies a force in the upward direction \vec{F}ⱼ of the screen in the state of FIG. 5. When a user performs an action of pushing up on the screen without changing a position of the contact point while holding the finger in contact with the screen 31, the direction of force is detected as the upward direction of the screen. In this case, the object 32 moves up on the screen.

Furthermore, FIG. 8 shows an execution status of a user command when a user applies a force in the downward direction \vec{F_{b}} of the screen in the state of FIG. 5. When a user performs an action of pulling down on the screen without changing the position of the contact point while holding the finger in contact with the screen 31, the direction of force is detected as the downward direction of the screen. Thus the object 32 moves down on the screen.

In addition, as shown in FIG. 9, when a user performs an action of pushing back on the screen without changing the position while holding his/her finger in contact with the screen 31, the direction of force is detected as the backward direction \vec{F}ₙ of the screen. In this case, the object 32 may be displayed as being further backward or reduced.

As described above, when a user command is executed according to the direction of force, the user command may be executed, intuitively matching with the manipulation (an action) of the user. Accordingly, the user can manipulate the screen intuitively and easily.

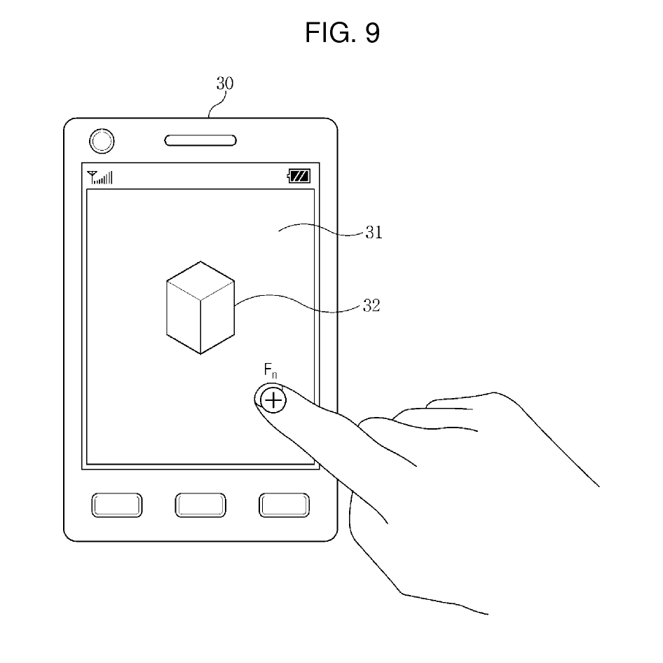

Next, FIG. 10 is an exemplary diagram showing an execution status of a user command of a user interface screen according to a second embodiment of the present invention. When a user performs an action of coming into contact with the touch region of the screen 31 and rotating in a clockwise direction without changing a position of the contact, a pattern P of change in a direction (clockwise direction) of force is detected. Thus, an object 32 displayed on the screen 31 may be displayed as rotating in the clockwise direction.

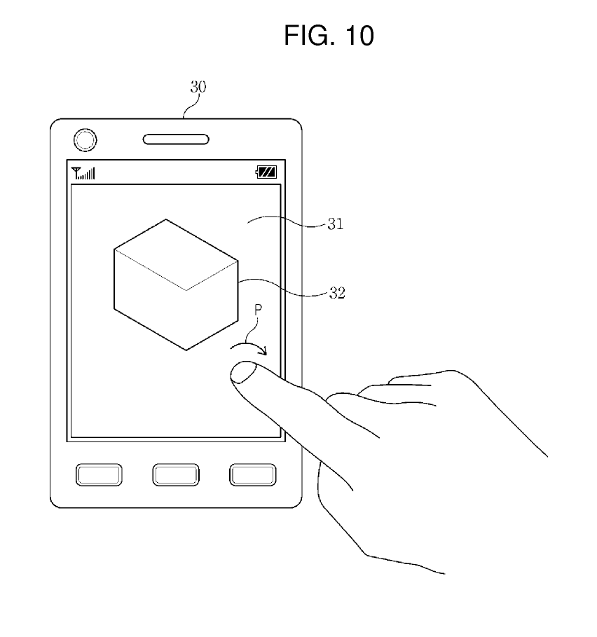

FIG. 11 is a view illustrating a process of detecting the pattern P of change in the direction of force.

Referring to FIG. 11, when directions of force F1, F2, F3, and F4 applied to a specific contact point are detected at predetermined sampling intervals using the above-described method or sensor as shown in FIG. 4, the portable terminal device 30 sequentially connects the detected directions of force with each other and detects the connection line as the change pattern of the direction of force. In the present embodiment, a pattern that rotates in the clockwise direction is detected.

Accordingly, the portable terminal device 30 according to the present invention may detect the change pattern of the direction of force, which is represented within a certain time period, as a “clockwise rotation,” and may rotate the object 32 that is output to the user interface screen 31 in the clockwise direction according to the predetermined user command upon detecting the pattern as the clockwise rotation.

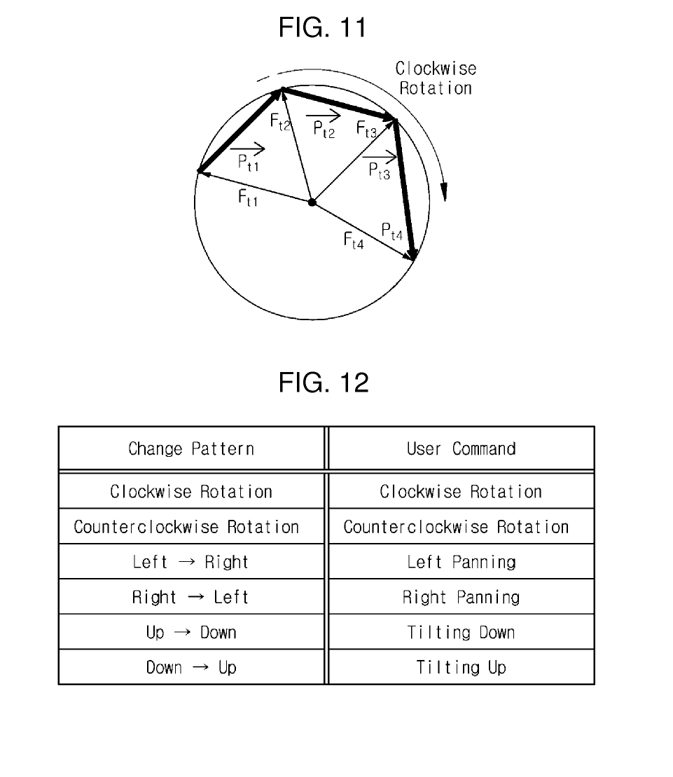

FIG. 12 is a table showing an example of setting a change pattern of a direction of force to be detected and a corresponding user command in a second embodiment of the present invention.

Referring to FIG. 12, in the second embodiment of the present invention, the change pattern of the direction of force such as a clockwise rotation, a counterclockwise rotation, a left-to-right movement, a right-to-left movement, an up-to-down movement, and a down-to-up movement may be detected, and one of rotation, movement, panning, tilting, zooming-in, and zooming-out of a screen or a specific object output to the screen may be set as a user command mapped with the change pattern of the direction of force.

For example, when the direction of force applied to the contact point is rotated in a clockwise/counterclockwise direction and changed, the screen or the specific object may be rotated in the rotation direction. Moreover, the tilting or panning may be performed by changing the direction of force applied to one or more combination patterns of a left side, a right side, an upper side, and a lower side of the direction of force.

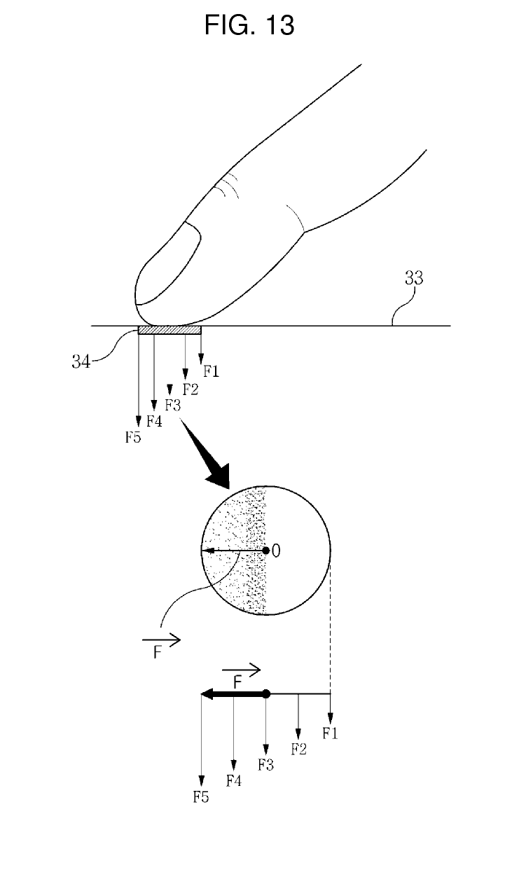

Finally, FIG. 13 is a schematic diagram showing an example of detecting the direction of force using the intensity of force in a method of providing a user interface according to the present invention.

Referring to FIG. 13, when a user contact is applied to one point in a touch region 33, a contact region 34 with a certain area is set or extracted based on a point where a finger of a user is in contact with a surface of the touch region 33. The contact region 34 may be set as a range of a predetermined area with respect to specific coordinates (e.g., center coordinates) of the point or set by connecting multiple adjacent sensing points that sense the user contact among multiple sensing points included in the touch region 33.

In addition, the intensities of force F1 to F5 detected at the multiple sensing points of the predetermined or extracted contact region 34 are detected. A greater intensity of force may be detected at the sensing point of the direction in which a user applies a force in the contact region 34.

Accordingly, the portable terminal device 30 according to the present invention detects, as the direction of force applied to the contact region 34, a direction of a sensing point having the greatest intensity of force among the multiple sensing points with respect to the center point of the contact region 34.

Accordingly, the present invention can be applied to an apparatus in which a sensor included in the touch input unit 110 cannot detect the direction of force by detecting the direction of force using the detected intensity of force.

Implementations of the subject matter and the functional operations described in this specification can be provided in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a tangible program carrier for execution by, or to control the operation of, data processing apparatus. The computer readable medium can be a machine readable storage device, a machine readable storage substrate, a memory device, a composition of matter effecting a machine readable propagated signal, or a combination of one or more of them.

While this specification contains many specifics, these should not be construed as limitations on the scope of what is being claimed or of what may be claimed, but rather as descriptions of features specific to particular embodiments.

Furthermore, even though operations are described in a certain order on the drawings, it should not be understood that the operations should be executed in the certain order or in a sequential order to obtain desired results, or that all the operations should be executed. In some cases, a multitasking and a parallel processing may be beneficial.

Although specific embodiments have been illustrated and described herein, it is obvious to those skilled in the art that many modifications of the present invention may be made without departing from what is intended to be limited solely by the appended claims. While preferred embodiments of the present invention have been described using specific terms, such description is for illustrative purposes only, and it is to be understood that changes and variations may be made without departing from the spirit or scope of the following claims.

### INDUSTRIAL APPLICABILITY

The method and apparatus for providing a user interface using a one-point touch according to the present invention have an excellent effect of executing various user commands by sensing contact with one point of a touch region, detecting a direction of force applied to the point while the contact with the point is maintained without changing a position of the contact, executing a user command according to the detected direction of force, and thus adjusting only the direction of force applied to the contact point without moving from a user touch at the specific point or drawing a complex pattern.

In particular, the present invention can enhance a user's convenience because the manipulation is enabled by adjusting only the direction of force after coming into contact with the specific point when the user manipulates a portable user device such as smartphone with one hand.

In addition, the present invention has an excellent effect of providing an instant and quick response result to a user by executing the user command according to the direction of the force applied to the contact point.

1. A method of providing a user interface using a one-point touch, the method being performed by an apparatus that includes a touch region capable of sensing contact and the method comprising:
sensing contact with one point in the touch region;
when the contact is sensed, detecting a direction of force applied to the point while the contact with the point is fixed; and
executing a predetermined user command according to the detected direction of force.

2. The method of claim 1, wherein the detecting of the direction of force comprises:
extracting a contact region with a certain area around the point where the contact is sensed;
detecting intensities of the force at multiple sensing points in the contact region; and
determining a direction of the force applied to the point based on a distribution of the detected intensities of the force at the multiple sensing points.

3. The method of claim 2, wherein the determining of the direction of the force comprises determining, as the direction of the force, a direction of a sensing point where a greatest intensity of force is detected with respect to a center of the contact region.

4. The method of claim 1, wherein the determining of the direction of force comprises determining the direction of force in a two-dimensional (2D) plane based on the touch region or in a three-dimensional (3D) space further including a downward direction perpendicular to the touch region.

5. The method of claim 1, wherein the executing of the predetermined user command comprises performing one or more of rotation, movement, zooming-in, zooming-out, panning, and tilting of a specific object or screen according to the direction of force.

6. The method of claim 1, further comprising detecting an intensity of the force applied to the point,
wherein the executing of the user command comprises executing the user command in consideration of the detected direction and the intensity of the force.

7. A method of providing a user interface using a one-point touch, the method being performed by an apparatus that includes a touch region capable of sensing contact and the method comprising:
sensing contact with one point in the touch region;
when the contact is sensed, detecting a direction of force applied to the point at certain intervals while the contact with the point is fixed;
detecting a change pattern of the direction of force according to when the direction of force is detected; and
executing a predetermined user command according to the detected change pattern.

8. The method of claim 7, wherein the detecting of the direction of force comprises:
extracting a contact region with a certain area around the point where the contact is sensed;
detecting intensities of the force at multiple sensing points in the contact region; and
determining a direction of the force applied to the point based on a distribution of the detected intensities of the force at the multiple sensing points.

9. The method of claim 8, wherein the determining of the direction of the force comprises determining, as the direction of the force, a direction of a sensing point where a greatest intensity of force is detected with respect to a center of the contact region.

10. The method of claim 7, wherein the extracting of the change pattern comprises sequentially connecting directions of force to extract the change pattern of the direction of force.

11. The method of claim 7, wherein the executing of the predetermined user command comprises performing one or more of rotation, movement, zooming-in, zooming-out, panning, and tilting of a specific object or screen according to the change pattern.

12. The method of claim 7, further comprising detecting an intensity of the force applied to the point,
wherein the executing of the user command comprises executing the user command in further consideration of the intensity of the force in addition to the detected change pattern of the direction of force.

13. An apparatus comprising:
a touch input unit including a touch region capable of sensing contact and configured to detect one or more of contact with the touch region, a position of the contact, an intensity of force when the contact is applied, and a direction of the force; and
a control unit configured to, when contact with one point in the touch region is sensed, detect a direction of force applied to the point or a change pattern of the direction of force while the contact to the point is fixed and execute a predetermined user command according to the detected direction of force or the detected change pattern of the direction of force.

14. The apparatus of claim 13, wherein the control unit comprises a touch event processing module configured to set a contact region with a certain area around the point where the contact is sensed, compare intensities of force at multiple sensing points located in the contact region, and determine the direction of force applied to the point.

15. The apparatus of claim 14, wherein the touch event processing module determines, as the direction of force, a direction of a sensing point where a greatest intensity of force is detected with respect to a center of the contact region.

16. The apparatus of claim 13, wherein the control unit comprises a change pattern extraction module configured to extract a change pattern of the direction of force by sequentially connecting directions of force detected within a certain time period while the contact with the point is fixed.
